(19) United States
(12) Patent Application Publication
(10) Pub. No.: US 2009/0317178 A1
(43) Pub. Date: Dec. 24, 2009

(54) Tube folder

(76) Inventor: Ping-Tien Wang, Tainan (TW)

Correspondence Address: BACON & THOMAS, PLLC, 625 SLATERS LANE, FOURTH FLOOR, ALEXANDRIA, VA, 22314-1176, US

(21) Appl. No.: 12/213,630

(22) Filed: Jun. 23, 2008

(51) Int. Cl. F16C 11/00; B62K 15/00

(52) U.S. Cl. 403/150; 403/100; 403/102; 280/287

(57) ABSTRACT

A tube folder includes a top shell, a bottom shell and an instant clasp set; wherein the top shell is provided with two sets of lug holes; the bottom shell is provided with two plug tubes; the instant clasp set covers a dismount handle which has a set of joined segments at its terminal, and an empty space formed in between the two joined segments; and a shaft, fitted in the empty space of the joined segments; each set of the lug holes and corresponding plug tube has been bound by a hinge, so does the joined segments of the dismount handle and the shaft; the surfaces of the top and the bottom shells are shaped into reinforcing ribs, providing handy fitting and enhanced joint when connecting to the tubes.

### BACKGROUND OF THE INVENTION

1. Field of the Invention

The present invention relates to a tube folder made up of a top shell, a bottom shell and an instant clasp set, where the top and bottom shells of the tube folder are provided in between with two sets of pivotal portions, and each is formed by two lug holes joining a plug tube and bound by a hinge, whereas the resultant hinge, after assembling the pivotal portions and the instant clasp set, is composed of three sectors, which balance the force exerted to eliminate the concentration of stress, and substantially boost the safety of usage.

2. Description of the Prior Art

A tube folder is a folding device formed by pivotally combining a top shell, a bottom shell and an instant clasp set; the surfaces of the top and the bottom shells are joined to different tubes respectively (welding and gluing are the most popular), and the tubes each other form a connected state once the top and bottom shells close up; by manipulating the instant clasp set to unlock the top and the bottom shells that enables the tubes to place side by side in position to form a folded state, where the most popular application lies in the connection and the folding for the frame of the foldable bikes, but the above example is to be considered illustrative, not restrictive. Prior art tube folders have their the top and the bottom shells form a pivotal portion in between by having a plug tube extended from a shell (top shell or bottom shell), and having another plug tube extended from the other shell (bottom shell or top shell) to position side by side, followed by using a hinge to pass through the plug tubes for a linkage, which facilitates the connection for the top and the bottom shells. During usage, the plug tube of each shell is used to link the plug tube of the other shell, where the plug tubes are deflected in setup and the hinge is passing through the whole plug tubes; therefore, the force exerted is not uniform over the shells, which results in the stress more concentrated on the joints between individual shell and its plug tubes, and it could be serious to produce breaks that threatens the safety of users, which deserves further improvement.

Moreover, as prior art tube folders are applied in the foldable bikes, the most common portion used for the application is in the main frame (that means the main frame locates down the seat cushion and joins the front frame with the back frame) that functions connection and folding. The common assembly of the tube folder to the main frame always comes with the instant clasp set installing at the right side as the bike moves ahead, which makes the instant clasp set operated with difficulty due to adjoining the front chain roller; as the main frame is folded, the instant clasp set is located at the inner side which surely results in the drawback that the space after the folding couldn't be shrunk sizably.

The inventor devotes himself to the research and manufacture in the bike industry, and he recognizes the potential danger of the foregoing drawbacks; therefore, he strives for perfection to delve into the advanced development, expecting to offer a tube folder that the force exerted is uniform over its top and bottom shells, and, eventually, a long study and modifications gave birth to the present invention.

### SUMMARY OF THE INVENTION

It is the main object of the present invention to offer a tube folder that the force exerted is uniform over its top and bottom shells, which helps to boost the safety of usage.

It is another object of the present invention to offer a tube folder that features handy fitting between tubes and shells, and boosts the stability of joint.

It is a further object of the present invention to offer a tube folder installed in the main frame of a foldable bike that functions either connection or folding, where the instant clasp set is installed at the left side as the bike moves ahead, which helps for easy handling and shrinking in size after the folding.

To accomplish the aforesaid objects, the inventor conceived the idea to build a tube folder, comprising a top shell, a bottom shell and an instant clasp set; wherein the top shell is provided with two sets of inclined downward lug holes; the bottom shell is provided with two inclined upward plug tubes; the instant clasp set covers a dismount handle which has a set of joined segments at its terminal, where the joined segments each has a plug hole deviated from the center, and an empty space formed in between the two joined segments; and a shaft, fitted in the empty space of the joined segments and placed side by side with the joined segments, having a hollow cylinder at its head end, to keep abreast with the plug holes of the joined segments; each plug tube of the bottom shell is placed to keep abreast with each set of lug holes of the top shell, and both the plug holes of the joined segments of the dismount handle and the hollow cylinder of the shaft are then together put in the middle space between the two sets of lug holes; each set of the lug holes and corresponding plug tube has been bound by a hinge, so does the plug holes of the joined segments of the dismount handle and the hollow cylinder of the shaft.

In the aforesaid tube folder, the surface of the top shell is shaped into reinforcing ribs, providing handy fitting and enhanced joint when connecting to the tubes.

In the aforesaid tube folder, the surface of the bottom shell is shaped into reinforcing ribs, providing handy fitting and enhanced joint when connecting to the tubes.

In the aforesaid tube folder, the reinforcing ribs are bar-shaped.

In the aforesaid tube folder, the reinforcing ribs are shaped the same form as the cross section of the tubes.

In the aforesaid tube folder, as the tubes join the reinforcing ribs, they can be plugging in the interior of the reinforcing ribs.

In the aforesaid tube folder, as the tubes join the reinforcing ribs, they can be plugging in the exterior of the reinforcing ribs.

In the aforesaid tube folder, as the tube folder is installed in the main frame of a foldable bike, the dismount handle is set up at the left side of the bike as it moves ahead.

### BRIEF DESCRIPTION OF THE DRAWINGS

FIG. 1 is a three-dimensional exploded diagram of the exemplified embodiment of the present invention;

FIG. 2 is a three-dimensional assembled outside view of the exemplified embodiment of the present invention;

FIG. 3 is an assembled sectional view of the pivotal portion of the exemplified embodiment of the present invention;

FIG. 4 is a side view for the link between the tubes and the exemplified embodiment of the present invention;

FIG. 5 is a schematic diagram of the top view of a variation of the reinforcing rib of the exemplified embodiment of the present invention;

FIG. 6 is a schematic diagram of the top view of another variation of the reinforcing rib of the exemplified embodiment of the present invention;

FIG. 7 is a schematic diagram of the top view of a further variation of the reinforcing rib of the exemplified embodiment of the present invention; and

FIG. 8 is a schematic diagram of the exemplified embodiment of the present invention installed in the main frame of a foldable bike.

### DETAILED DESCRIPTION OF THE INVENTION

To achieve the aforesaid objects of the present invention, the techniques adopted and the functions achieved are detailed described with reference to the following preferred embodiments and the accompanying drawings, which would help the honorable examiner to have a thorough comprehension.

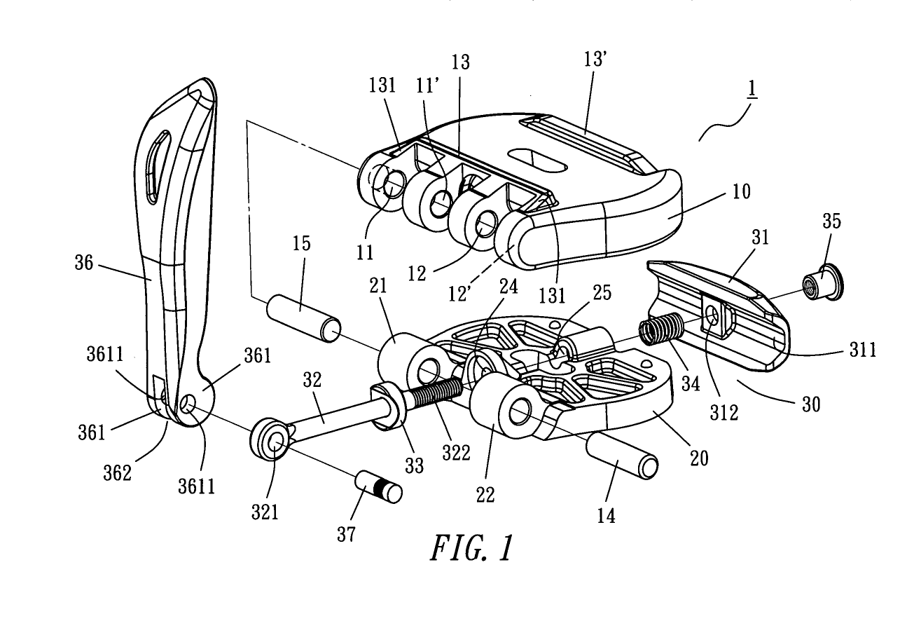

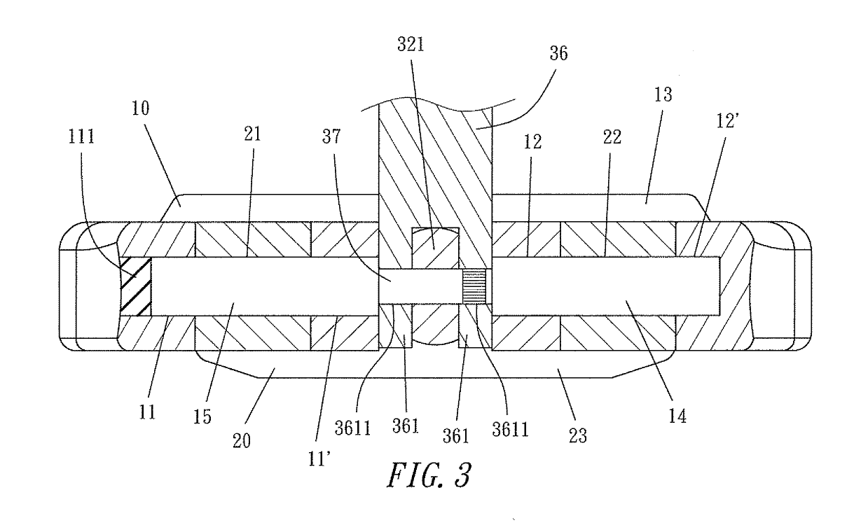

Referring to FIGS. 1&2, the exemplified embodiment of the present invention is a tube folder 1, comprising a top shell 10, a bottom shell 20 and an instant clasp set 30; wherein the top shell 10 is provided at its back end with two sets (two pairs) of inclined downward lug holes 11, 11′ and 12, 12′, where the three lug holes 11, 11′ and 12 are manufactured into axial hollow for all while the lug hole 12′ has hollow inside but sealed outside; comparatively, the bottom shell 20 is provided at its back end with two inclined upward plug tubes with a axial hollow 21 and 22; the surface of the top shell 10 is shaped into two bar-shaped reinforcing ribs 13, 13′ (shown in FIGS. 1&2) and the surface of the bottom shell 20 is also shaped into two bar-shaped reinforcing ribs 23, 23′ (shown in FIGS. 3&4), wherein the reinforcing rib 13 near the lug holes 11, 11′, 12 and 12′ and the reinforcing rib 23 near the plug tubes 21, 22 are joining reinforcing bars 131, 231 which are inclined extensions from the surfaces of the top and the bottom shells 10, 20; besides, the bottom shell 20 is provided in its internal with a fitting hole 24 and a through cavity 25, and the top and the bottom shells 10, 20 each has a chunk at its front capable of being merged each other.

Referring to FIG. 1, the instant clasp set 30 comprises a clasp chunk 31, a shaft 32, a fitting spacer 33, an elastic element 34, a joint element 35 and a dismount handle 36; wherein the clasp chunk 31 has a catch trough 311 at its inner side, a through hole 312 at its center; the shaft 32 has a hollow cylinder 321 at its one end while the other end is provided with joined threads 322 at its surface; the fitting spacer 33 is flexible in nature; the elastic element 34 is compressible; the joint element 35 has joined threads internally; the dismount handle 36 is provided with a set of joined segments 361 at the terminal opposite to the handle, where the two joined segments 361 form a lodging space 362 in between, and a plug hole 3611 deviated from the center is set up at each of the joined segments 361. Referring to FIG. 3, during the assembly the two sets (two pairs) of lug holes 11, 11′ and 12, 12′ of the top shell 10 are aligned with the plug tubes 21, 22 of the bottom shell 20 respectively for a side by side placement, which is to place the plug tube 21 in between the two lug holes 11, 11′ for keeping abreast, and to place the plug tube 22 in between the two lug holes 12, 12′ for keeping abreast; then, inserting a first hinge 14 into the lug hole 11 from its one side, and passing through the lug hole 11, the plug tube 21, the lug hole 11′, the lug hole 12, the plug tube 22 and the lug hole 12′ for a fixing; again, inserting a second hinge 15 the same way from one end of the lug hole 11, through the plug tube 21 and the lug hole 11′ for a fixing;

The procedure of assembly proceeds to place (insert) the terminal having a hollow cylinder 321 of the shaft 32 into the lodging space 362 of the dismount handle 36 for keeping abreast with the joined segments 361, and to align the plug holes 3611 of the joined segments 361 with the hollow cylinder 321 of the shaft, followed by inserting a third hinge 37 through the plug holes 3611 and the hollow cylinder 321 for a fixing, which joins the shaft 32 with the dismount handle 36; the shaft 32 is pushed to have its end having joined threads 322 pass from back to front through the fitting spacer 33, the fitting hole 24 and the through cavity 25 of the bottom shell 20, and the elastic element 34 and the through hole 312 of the clasp chunk 31 in order, followed by joining the internal joined threads of the joint element 35 with the external joined threads 322 of the shaft 32, which fits the catch trough 311 in the clasp chunk 31 to the chunk merged out of the front ends of the top and the bottom shells 10, 20; while in this state, the same terminals for the dismount handle 36 and the shaft 32 that are inserted by the third hinge 37 are perfectly fitted in the space between the lug holes 11′ and 12 with a firm lodge. Lastly, it is optional to seal the open end of the lug hole 11 to avoid the hinges 15, 37 and 14 from coming off, for instance: to exploit filling substance 111 to seal the open end shown in FIG. 3, or to use welding means to block the passage, or to utilize a destructive means in producing lumpy blockage, and the like, eventually to fulfill the assembly for the tube folder 1 of the exemplified embodiment of the present invention.

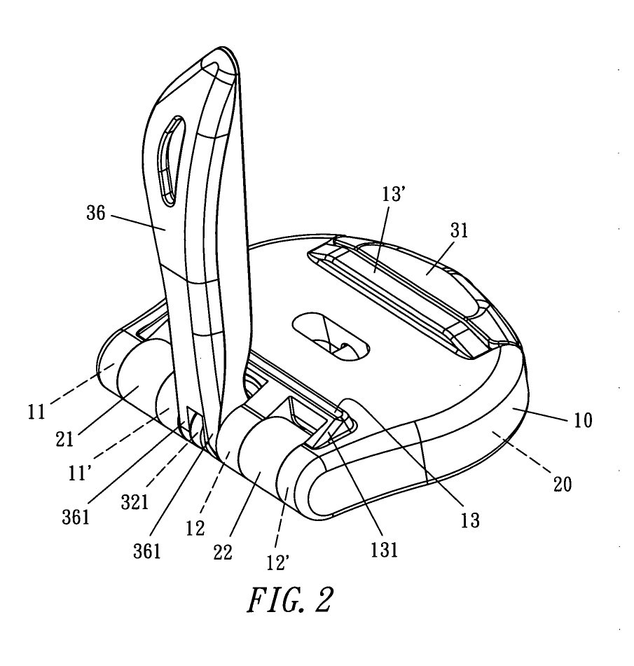

The dismount handle 36 is being rotated around the third hinge 37 when the invention is in use, due to the deviation of the plug hole 3611 from the center of the joined segment 361 of the dismount handle 36, as the wider edge of the joined segments 361 is operated to jostle against the fitting spacer 33, which will press the elastic element to pull back the shaft 32, to enable the catch trough 311 in the clasp chunk 31 to grip the chunk merged by the front ends of the top and the bottom shells 10, 20, to prevent the top and the bottom shells from being bent, as shown in FIG. 2; when rotating the dismount handle 36 reversely, to make the narrower edge of the joined segment 361 to jostle against the fitting spacer 33, the shaft 32 is being pushed forward by the rebound force of the elastic element 34, which makes the catch trough 311 of the clasp chunk 31 to release the hold for the chunk of the top and the bottom shells, to open the top and the bottom shells 10, 20 for folding.

It is essential to note that the chunk is made up of the front ends of the top and the bottom shells 10, 20, wherein the chunk of the bottom shell 20 is devised to be a bit longer than that of the top shell 10, since the shaft 32 and the clasp chunk 31 actually are installed to attach on the bottom shell 20 (instead of the top shell 10), as the clasp chunk 31 moves forward to release the gripping on the chunk, the top shell 10 with shorter chunk is handy to get out of the range of the catch trough 311 and rotate up to lift; on the other hand, the front edge of the longer chunk of the bottom shell 20 is still within the range of the catch trough 311, which prohibits the clasp chunk 31 from rotating around the joint element 35.

It is apparent that the joint of the top and the bottom shells 10, 20 is done by placing the plug tube 22 in between the two lug holes 12, 12′ followed by inserting the first hinge 14 to form the first pivotal portion at one side, and inserting the other plug tube 21 in between the other two lug holes 11, 11′ followed by inserting the second hinge 15 to form the second pivotal portion at the other side. Since the first and the second pivotal portions are evenly distributed along the two sides, the force exerted over the portions is therefore even, which substantially eliminates the concentration of stress. Moreover, as each pivotal portion is concerned, it is made up of two lug holes 11, 11′ (or 12, 12′) with a plug tube 21 (or 22) placed in between followed by a hinge 15 (or 14) inserting through them, the force exerted over each portion is also even, which eliminates the concentration of stress too, and considerably boosts the safety of usage. Besides, the pivotal portions join the instant clasp set 30 to form a resultant hinge which is made up of three sectors: the first hinge 14, the second hinge 15 and the third hinge 37, where each acts its own without interactions one another to level down wastage, and to lift safety.

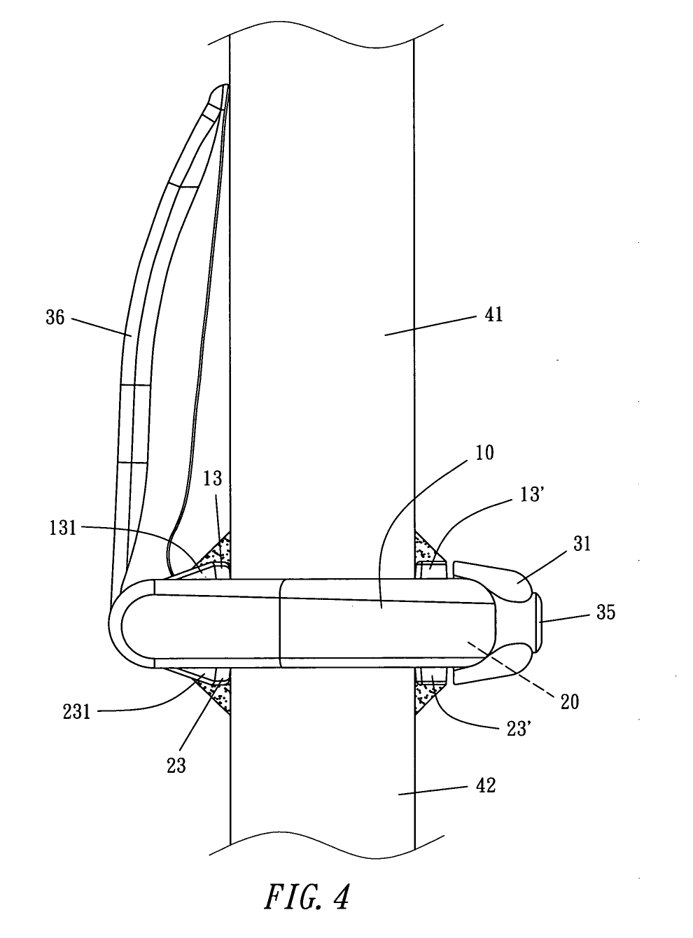

The actual usage of the tube folder 1 of the exemplified embodiment of the present invention is shown in FIG. 4, where the surfaces of the top and the bottom shells 10, 20 are offering link to a first tube 41 and a second tube 42 (could be welding or gluing or the like joining means), and the other trait of the present invention is the surfaces of the top and the bottom shells 10, 20 each is formed two reinforcing ribs 13, 13′ and 23, 23′ respectively, where the intervals of the ribs are designed to equate the widths of the first tube 41 and the second tube 42, which fits the first tube 41 and the second tube 42 easily in the space between the reinforcing ribs 13, 13′ and 23, 23′, and which does help in the fitting; for the further enforcement on joint (for instance: welding or gluing or the like means), the existence of the reinforcing ribs 13, 13′ and 23, 23′ can well be counted on for the solid joint; for instance, during welding the solder will fill in the gaps between the reinforcing ribs 13, 13′, 23, 23′ and the tubes 41, 42, even the surfaces of the reinforcing ribs 13, 13′, 23, 23′ are subject to the melting, which sizably strengthen the joint on the side of the tubes 41, 42; again: during gluing the glue will fill in the gaps between the reinforcing ribs 13, 13′, 23, 23′ and the tubes 41, 42; therefore, the existence of the reinforcing ribs 13, 13′ and 23, 23′ can well be counted on for the solid joint between the top and the bottom shells 10, 20 and the tubes 41, 42.

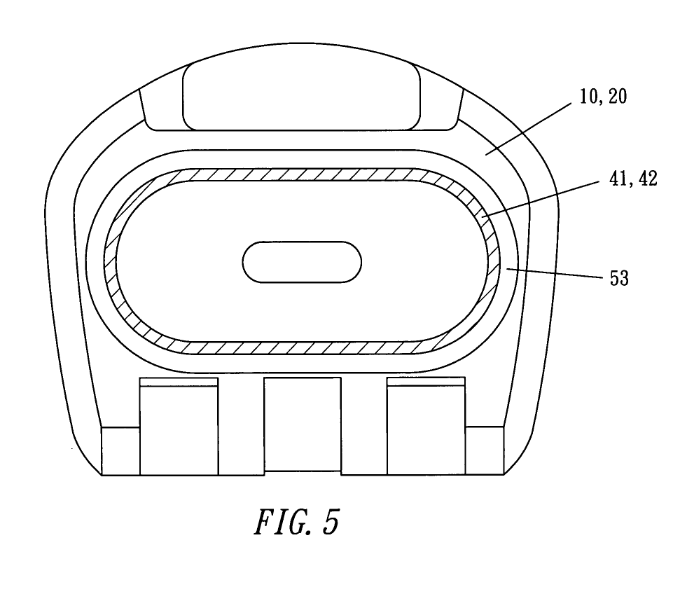

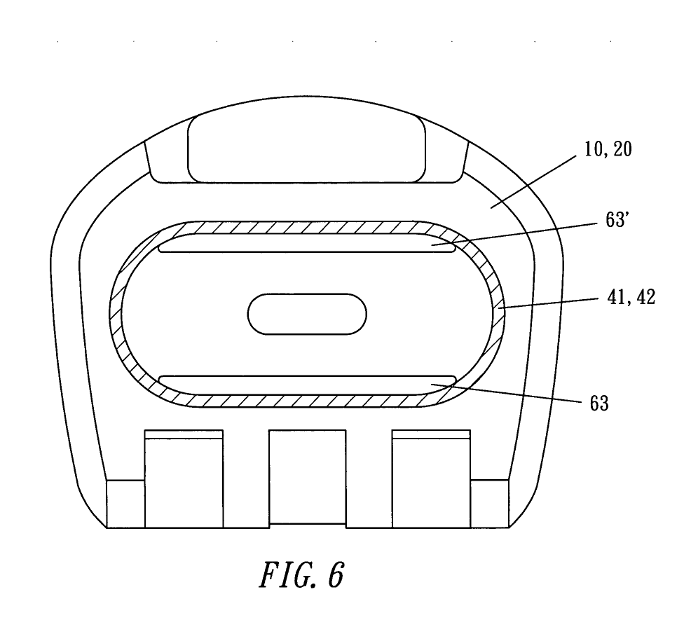

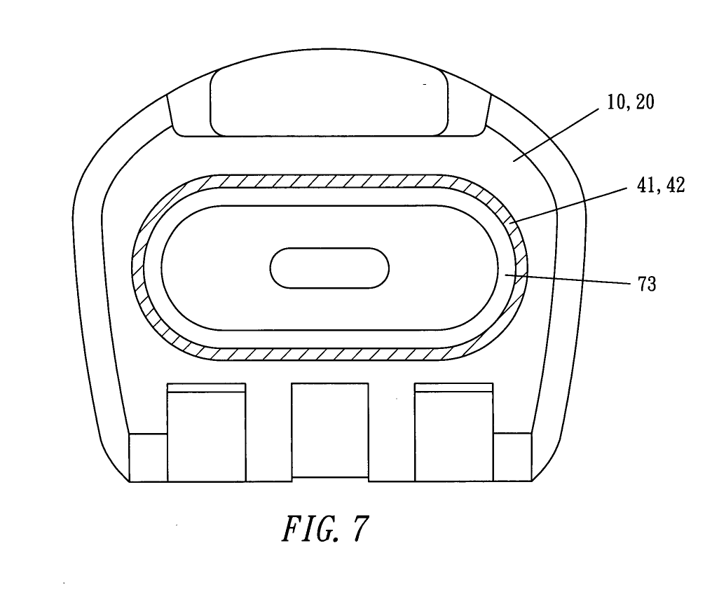

The existence of the reinforcing ribs on the surfaces of the top and the bottom shells 10, 20 is not restricted to bar-shaped, like that shown in FIG. 5, an oval-shaped (to harmonize with the cross section of the tube) reinforcing rib 53 each is formed on the surfaces of the top and the bottom shells 10, 20; during usage, the tubes 41, 42 are inserting within the inner rim of the reinforcing rib 53, followed by enhanced solid joint. Furthermore, the joining of tubes 41, 42 and the reinforcing ribs are also not restricted by the type of enclosing the tube inside the reinforcing rib, and it could be that in FIG. 6, where the surfaces of the top and the bottom shells 10, 20 are formed into bar-shaped reinforcing ribs 63, 63′, and the tubes 41, 42 cap the reinforcing ribs 63, 63′ instead, that is the inner rim of the tubes 41, 42 closely stick to the reinforcing ribs 63, 63′, followed by enhanced solid joint. It could surely be that in FIG. 7, where the surfaces of the top and the bottom shells 10, 20 each is formed into an oval-shaped (to harmonize with the cross section of the tube) reinforcing rib 73, and the tubes 41, 42 cap the reinforcing ribs 73 during assembly, that is the inner rim of the tubes 41, 42 closely stick to the reinforcing ribs 73, followed by enhanced solid joint. It is understood that various changes in form and detail may be made therein are within the scope of the claim of the present invention.

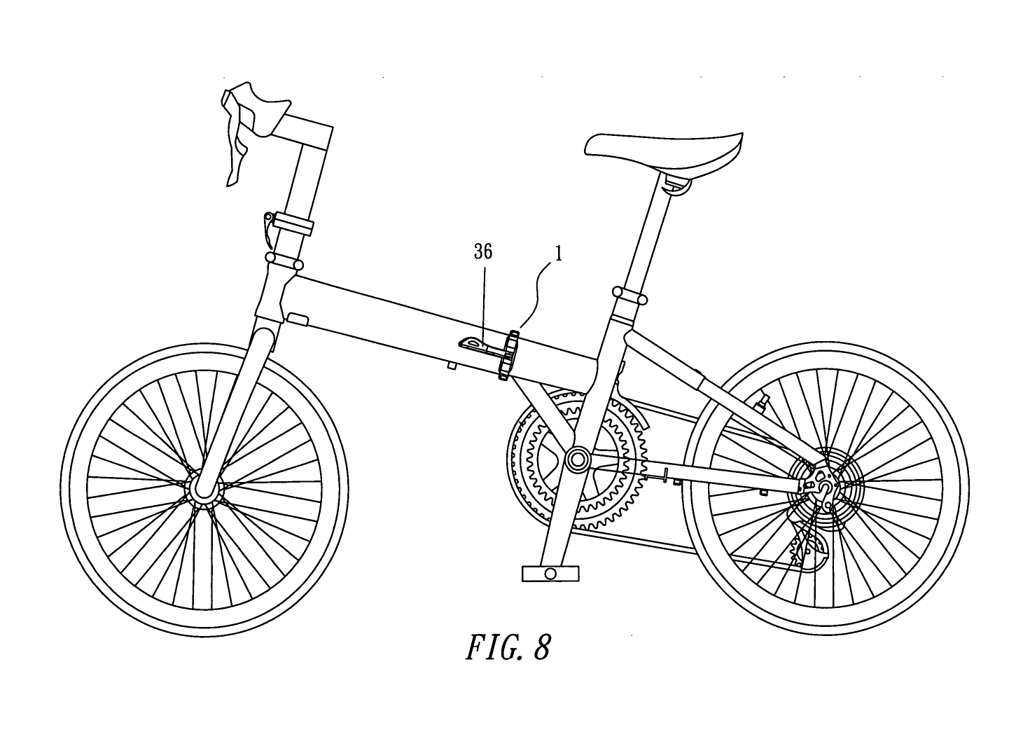

The most popular application of the tube folder of the present invention lies in the connection and the folding for the frame of foldable bikes, but the actual usage is not restricted to the foregoing one. When used in the foldable bikes, the most common portion used for the application is in the main frame (that means the main frame locates down the seat cushion and joins the front frame with the back frame) that functions connection and folding. In FIG. 8, as the tube folder of the present invention is installed in the main frame of the foldable bikes, the dismount handle is set up at the left side of the bike as it moves ahead for handy operation (free of the bothering by the front chain roller), and the dismount handle will not be contained by the folded frame, which would reduce the folded space.

Accordingly, the present invention features two set of pivotal portions, where each is formed by two lug holes with a plug tube, which are located in between the top and the bottom shells of the tube folder, and the pivotal portions join the instant clasp set to form a resultant hinge which is made up of three sectors, where the even exertion of force eliminates the concentration of stress, to considerably boost the safety of usage; meanwhile, the surfaces of the top and the bottom shells of the tube folder are formed into reinforcing ribs, which is handy for fitting the connected tube and lifting the strength of joint; when installing in the main frame of a foldable bike, the dismount handle is set up at the left side of the bike as it moves ahead, which targets for handy operation and reducing the folded space. The disclosed tube folder of the present invention has not opened to the public for its structure and composition, which is construed to be novel and useful and is compliant to the requirements of a utility patent. An application is now for filing, which deserves your favorable examination and approval.

1. A tube folder, comprising a top shell, a bottom shell and an instant clasp set; wherein said top shell is provided with two sets of inclined downward lug holes; said bottom shell being provided with two inclined upward plug tubes; said instant clasp set including a dismount handle which has a set of joined segments at its terminal, where the joined segments each has a plug hole deviated from the center, and an empty space formed in between the two joined segments; and a shaft having a hollow cylinder at a head end thereof fitted in the empty space of the joined segments adjacent the plug holes of the joined segments; each plug tube of said bottom shell being placed to keep abreast with each set of lug holes of said top shell, and both the plug holes of the joined segments of the dismount handle and the hollow cylinder of the shaft being then together put in a middle space between the two sets of lug holes; each set of the lug holes and coffesponding plug tube, and the plug holes of the joined segments of the dismount handle and the hollow cylinder of the shaft, are bound by a hinge respectively.

2. A tube folder as in claim 1 wherein the surface of said top shell is shaped into reinforcing ribs, providing handy fitting and enhanced joint when connecting to the tubes.

3. A tube folder as in claim 2 wherein the surface of said bottom shell is shaped into reinforcing ribs, providing handy fitting and enhanced joint when connecting to the tubes.

4. A tube folder as in claim 2 wherein the reinforcing ribs are bar-shaped.

5. A tube folder as in claim 2 wherein the reinforcing ribs are shaped the same form as the cross section of the tubes.

6. A tube folder as in claim 3 wherein when the tubes are connected to the reinforcing ribs of the top shell and the bottom shell, the tubes are coupled to an inner side of the reinforcing ribs.

7. A tube folder as in claim 3 wherein when the tubes are connected to the reinforcing ribs of the top shell and the bottom shell, the tubes are coupled to an outer side of the reinforcing ribs.

8. A tube folder as in claim 3 wherein the reinforcing ribs of the top shell and the bottom shell are bar-shaped.

9. A tube folder as in claim 3 wherein the reinforcing ribs of the top shell and the bottom shell are shaped to have the same form as the cross section of the tubes.

10. (canceled)

11. (canceled)

12. A tube folder as in claim 1 wherein the tube folder is installed in the main frame of a foldable bike, the dismount handle being set up at the left side of the bike as it moves forward.
